(19) United States
(12) Patent Application Publication
(10) Pub. No.: US 2010/0189319 A1
(43) Pub. Date: Jul. 29, 2010

(54) IMAGE SEGMENTATION SYSTEM AND METHOD

(76) Inventors: Dee Wu, Edmond, OK (US); Yao Jenny Lu, Pearland, TX (US); Rajibul Alam, Dhaka (BD)

Correspondence Address: DUNLAP CODDING, P.C., PO BOX 16370, OKLAHOMA CITY, OK, 73113, US

(21) Appl. No.: 12/616,742

(22) Filed: Nov. 11, 2009

Related U.S. Application Data
(63) Continuation of application No. PCT/US2008/063450, filed on May 12, 2008.
(60) Provisional application No. 60/928,807, filed on May 11, 2007.

(51) Int. Cl. G06K 9/34; G06K 9/46; G06T 7/00

(52) U.S. Cl. 382/128; 382/203; 382/173

(57) ABSTRACT

An image analysis system is described. The image analysis system includes a computer apparatus programmed to access at least one image and to register a plurality of starting points. The starting points are positionally referenced to an image boundary of a region of interest of the image. The computer apparatus is further programmed to analyze and connect the starting points to form at least one contour line. Through multiple opposing iterations the contour line delineates the image boundary.

### CROSS-REFERENCE TO RELATED APPLICATIONS

This application is a continuation of International Application No. PCT/US2008/063450, filed May 12, 2008, which itself claims priority to U.S. Provisional Application Ser. No. 60/928,807, filed on May 11, 2007, the entire contents of both applications are hereby incorporated by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE §1.52(E)(5)).

Not Applicable.

### BACKGROUND OF THE INVENTION

1. Field of the Invention

The present invention relates generally to image segmentation. More specifically, but not by way of limitation, the present invention relates to image segmentation using iterative deformational methodology.

2. Discussion of Related Art

Advancements in research and technology have revolutionized and proliferated imaging segmentation and expanded imaging techniques over several fields. These advanced image segmentation methods have provided scientists and physicians with tools to provide life-saving information through non-invasive techniques. In particular, the developing field of tumor delineation is providing critical information for the treatment and monitoring of cancer progression.

Tissue images are commonly used within the medical and veterinary fields in the diagnosis and/or treatment of afflictions. Images are captured through imaging techniques such as x-rays, computer tomography (CT), magnet resonance imaging (MRI), ultrasonic imaging, and the like.

MRI is increasingly being used in oncology for cancer staging, response assessment, and radiation treatment planning. Images obtained for MRI, provide an essential piece for radiation therapy planning. Improved tumor delineation can enhance the objectivity and efficiency in clinical produces. However, delineation generally depends heavily on the expertise and experience of the user regardless of subspecialty.

One compromise is the automation of delineation procedures. Such methods have promise in reducing the physical range of motion required in manual segmentation, which may reduce incidence of carpal tunnels or tendonitis in physicians. Further, supervised methods may also permit parameter adjustment that incorporate the supervising physician's specific knowledge. These methods can serve as a ‘verification’ check during the delineator's progress, and in some cases, may be turned over to a resident or radiation oncology dosimetrist to improve clinical efficiency. While automation is desired, techniques that rely solely on automated methods have not definitively provided high quality delineation, and thus are limited in clinical utility.

Deformable models have the ability to introduce a degree of automation and/or objectivity in image segmentation tasks. Additionally, deformable models have the ability to operate on a large variety of shapes, on structures disturbed by noise, and on objects with partial occlusion on edges. Deformable models employ a model-based approach, and as such, can be tailored to take a parametric form making them intuitive to use, control, and understand.

Active deformation segmentation also provides a relatively fast method to identify structures. For example, with active contours, curves are propagated to the boundaries of structures based on constraints using variational principles.

Active deformation models, commonly known as ‘snakes’, were popularized in the late 1980s by Kass, Witkin, and Terzopoulos. See Kass M, Witkin A, Terzopoulos D. Snakes: Active contour models. International Journal of Computer Vision 1988; 1(4):321-331; or Terzopoulos D, McInerney T. Deformable models and the analysis of medical images. Stud Health Technol Inform 1997; 39:369-378. Nearly all deformable models have fundamental similarities to the classic snake model. Snakes and deformable models have been applied to many medical imaging problems for vascular, cardiac, lung, and brain structures.

For example, Gupta et al., (see Gupta A, Von Kurowski L, Singh A, et al. Cardiac MR image segmentation using deformable models. Proc. of Computers in Cardiology 1993; London, UK. p 747-750) in an MR Cardiac imaging application, uses a multi-step active deformation method to describe ventricular wall segmentation. After identifying the outside heart wall, the interior wall segmentation was improved using the information on the extraluminal boundary to better control convergence of the interior wall.

It is well known that standard active contour methods have limitations because of their sensitivity to become unstable. These methods are particularly sensitive to procedure parameters. In some cases, shrinking and flattening can occur when executed without user supervision. One particular challenge is with multi-finger structures that are required to adequately delineate tumor invasion.

### BRIEF SUMMARY OF EMBODIMENTS

The present embodiments relate to an image analysis system. The image analysis system includes a computer apparatus programmed to access at least one image and to register a plurality of starting points. The starting points are positionally referenced to an image boundary of a region of interest within the image. The computer apparatus is further programmed to analyze and connect the starting points to form at least one contour line. Through multiple opposing iterations, the contour line delineates the image boundary.

Another embodiment includes a method of analyzing at least one image. The method includes the steps of accessing at least one image and identifying a region of interest within the image. At least two starting points relative to the region of interest within the image are positionally referenced to an image boundary. The starting points are connected to form a contour line or a contour surface. Opposing iterations are performed on the contour line delineate the image boundary of the region of interest.

Another embodiment includes a method of treating a living organism. The method includes the step of accessing at least one image of tissue within a living organism. A region of interest of the tissue is identified. A series of starting points are positionally referenced to an image boundary of the region of interest of the image. The starting points are connected to form at least one contour line. Multiple opposing iterations are performed on the surface line to delineate the image boundary. At least one type of therapy is delivered to at least of portion of tissue within the delineated image boundary.

### BRIEF DESCRIPTION OF THE SEVERAL VIEWS OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of the invention, and are therefore not to be considered limiting of its scope, for the invention may admit to other equally effective embodiments.

FIG. 1 is a pictorial diagram of one embodiment of an image analysis and treatment system constructed in accordance with the present invention.

FIG. 2a is a pictorial diagram of the lower portion of a human torso, illustrating a cancerous uterine tumor for which the systems and methods of the present invention may be used to analyze, diagnose, and/or treat.

FIG. 2b is an enlarged view of the uterus and uterine tumor of FIG. 2a.

FIG. 3a-3g are enlarged views of the tumor of FIGS. 2a and 2b, depicting an exemplary segmentation scheme for determining the outer boundary of the tumor.

FIG. 4a is an enlarged view of the tumor for FIGS. 2a and 2b, depicting another exemplary segmentation scheme for determining the outer boundary of the tumor.

FIG. 4b is a sequence of images of the tumor of FIGS. 2a and 2b, depicting another exemplary segmentation scheme for determining the outer boundary of the tumor.

FIG. 5 is an enlarged view of the tumor of FIGS. 2a and 2b, depicting another exemplary segmentation scheme for determining the outer boundary of the tumor.

FIG. 6 is an enlarged view of the tumor of FIGS. 2a and 2b, depicting an exemplary segmentation scheme for analyzing the tumor.

FIG. 7 depicts an exemplary mean signal response distribution for the segmented tumor of FIG. 6, obtained using known DCE-MRI techniques.

### DETAILED DESCRIPTION OF EXEMPLARY EMBODIMENTS

### 1. System Overview

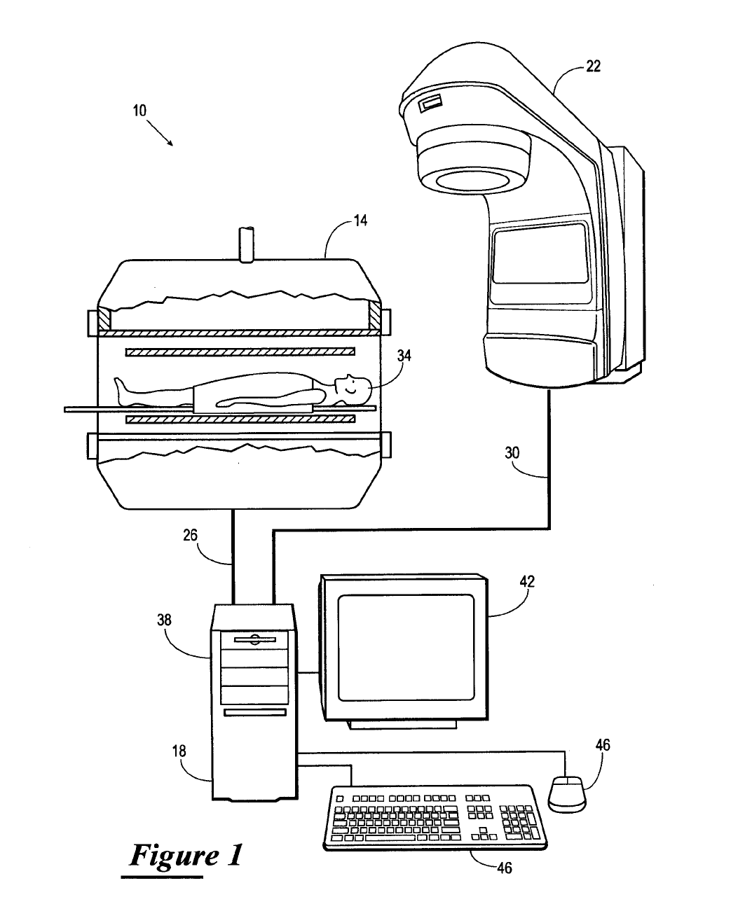

Referring now to the figures, and more particularly to FIG. 1, an image analysis and/or treatment system 10 is shown constructed in accordance with the present invention. The system 10 is preferably adapted to access an image having one or more image boundaries within the image. Image boundaries may include organ boundaries, tumor boundaries, and/or the like. The system 10 uses iterative deformational methodology to provide semi-automated segmentation and/or manually segmentation of the image boundary.

In one embodiment, the system 10 provides image segmentation methods to aid in tumor delineation and the monitoring of cancer progression, improving objectivity and efficiency within the clinical environment. Although the following description is related to medical imaging, the invention applies to all fields concerning and/or involving image segmentation, including, but not limited to: general photography, satellite imagery, face recognition systems, machine vision, and/or the like.

Generally, the system 10 comprises an image recording apparatus 14, a computer apparatus 18, and a treatment apparatus 22. As illustrated in FIG. 1, the computer apparatus 18 is in communication with the image recording apparatus 14 and with the treatment apparatus 22, via communication paths 26 and 30, respectively. Although the communication paths 26 and 30 are shown as wired paths, the communication paths 26 and 30 may be any suitable means for transferring data, such as, for example, a LAN, modem link, direct serial link, and/or the like. Similarly, the communication paths 26 and 30 may be wireless links such as, for example, radio frequency (RF), Bluetooth, WLAN, infrared, and/or the like.

It should also be understood that the communication paths 26 and 30 may be direct or indirect, such that the data transferred therethrough may travel through intermediate devices (not shown) such as servers and the like. The communication paths 26 and 30 may also be replaced with a computer readable medium (not shown) such as a CD, DVD, flash drive, remote storage device, and/or the like. For example, data from the image recording apparatus 14 may be saved to a CD and the CD transferred to the computer apparatus 18. Similarly, for example, the computer apparatus 18 could output data to a remote storage device (not shown) that is in communication with both the computer apparatus 18 and the treatment apparatus 22, such that the treatment apparatus 22 is able to retrieve data from the remote storage device.

The image recording apparatus 14 may be any suitable device capable of capturing at least one image of tissue on or within a living organism 34 and either storing or outputting the image. For example, the image recording apparatus 14 may be a magnetic resonance imaging (MRI) device utilized in conjunction with a contrast agent to obtain series of dynamic contrast enhanced (DCE) MRI images. One example of an appropriate MRI device is the Signa HDx 1.5T, available from GE Healthcare, 3000 North Grandview Blvd., Waukesha, Wis. One example of a suitable contrast agent is Gadopentetate dimeglumenine (Gd). Such DCR-MRI methods are well known in the art, and any suitable contrast agent may be employed.

In other embodiments, the image recording apparatus 14 may be any suitable device, utilizing, for example, x-ray techniques, nuclear imaging techniques, computed tomographic (CT) techniques, ultrasonic techniques, MRS spectroscopy techniques, a positron emission tomographic (PET) techniques, and/or hybrid techniques, or the like. Hybrid techniques may include any combination of the imaging techniques listed above and/or any other imaging techniques suitable for implementation of the system 10. For example, in one embodiment of a hybrid technique, commonly referred to in the art as image fusion, the user can acquire different images sets on MRI and PET at a substantially simultaneous time and position. This provides a user with the anatomical detail of the MRI and the quantitative physiological imaging of the PET.

Generally, the image recording apparatus 14 captures two-dimensional images. As will be appreciated by those skilled in the art, two-dimensional images will preferably include a plurality of pixels of equal size. In other embodiments, the pixels may be of unequal size, or may represent unequal amounts of tissue, such as in an oblique image, as long as the amount of tissue represented by a single pixel can be determined, such as from the position of the image recording device 14 relative to the tissue in the image.

In other embodiments, the image recording apparatus 14 captures two-dimensional images at known times or time points such that images are temporarily related to one another. Additionally, in capturing two-dimensional images, the image recording apparatus 14 may capture data pertaining to the third dimension such that the two-dimensional images can be spatially related to one another. As will be appreciated by those skilled in the art, a series of two-dimensional images or “slices” may be spatially related, either parallel, perpendicular, or otherwise, to one another and data interpolated therebetween to create a three-dimensional model or other representation of the tissue. Such a three-dimensional model may be used to create, or may be in the form of, a three-dimensional image. The image recording apparatus 14 may also capture data pertaining to the time at which the three-dimensional image is captured for four-dimensional analysis.

In one embodiment, the computer apparatus 18 is any suitable device capable of accessing and analyzing at least one image of tissue within the living organism 34, such as those captured by the image recording apparatus 14. For example, the computer apparatus 18 may include a central processing unit (CPU) 38, a display 42, and one or more input devices 46. The CPU 38 may include a processor, random access memory (RAM), and non-volatile memory, such as a hard drive. The display 42 is preferably a tube monitor, plasma screen, liquid crystal display, or the like, but may be any suitable device for displaying or conveying information in a form perceptible by a user, such as a speaker, printer, or the like.

The one or more input devices 46 may be any suitable device, such as a keyboard, mouse, stylus, touchscreen, microphone, and the like. In one embodiment, the input device 46 includes a microphone for providing command signals to the computer apparatus 18. Additionally, the one or more input devices 46 may be integrated, such as a touchscreen or the like.

The CPU 38 may be integrated and/or remotely located from the display 42 and/or input device 46. Similarly, the display 42 and input device 46 may be omitted entirely, such as, for example, in embodiments of the system 10 that are fully-automated, or otherwise do not require a user to directly interact with the computer apparatus 18. As will be discussed in more detail below, the computer apparatus 18 is programmable to perform a plurality of automated, semi-automated, and/or manual functions to identify, segment, and/or analyze segments of a region of interest within the at least one image.

The treatment apparatus 22 may be any suitable means for delivering at least one type of therapy to at least one segment or portion of a region of interest. In one embodiment, the treatment apparatus 22 is a radiation therapy (RT) device capable of delivering radiation therapy (RT) in a targeted manner to a region of interest, such as a tumor, on or within an organism 34. In other embodiments, the treatment apparatus 22 may be any device, machine, or assembly capable of delivering any suitable type of therapy in a targeted manner, such as, for example, radiation therapy, chemotherapy, drug therapy, surgical therapy, nuclear therapy, brachytherapy, heat therapy, laser therapy, ultrasonic therapy, and/or the like. For example, the treatment apparatus 22 may deliver a targeted injection of a chemotherapy agent or another drug to at least one segment of a region of interest. Similarly, the treatment apparatus 22 may perform robotic surgery to explore, investigate, and/or remove at least a portion of a region of interest. In yet further embodiments, the treatment apparatus 22 may be operated by, or work in conjunction with, a human surgeon, such as in laparoscopic surgery or similar techniques.

In other embodiments, the image recording apparatus 14 and the treatment apparatus 22 may be omitted, such that the system 10 includes the computer apparatus 18. In such an embodiment, the computer apparatus 18 would access the at least one image from either a memory device within, or in communication with, the computer apparatus 18, or from a computer readable medium such as a CD, DVD, flash drive, and/or the like.

In another embodiment, the system 10 includes the computer apparatus 18 and the treatment apparatus 22, such that upon analyzing at least one image of a region of interest of tissue, the computer apparatus 18 transmits data to cause the treatment apparatus 22 to deliver at least one type of therapy to at least one segment of a region of interest.

In yet another embodiment, the treatment apparatus 22 may be omitted, such that the system 10 includes the image recording apparatus 14 and the computer apparatus 18, such that the computer apparatus 18 may access and analyze at least one image captured by the image recording apparatus 14, and output the results of the analysis to a user, such as, for example, by way of the display 42, or by way of a computer readable medium, such as a CD, DVD, flash drive, or the like.

### 2. System Operation and Methods

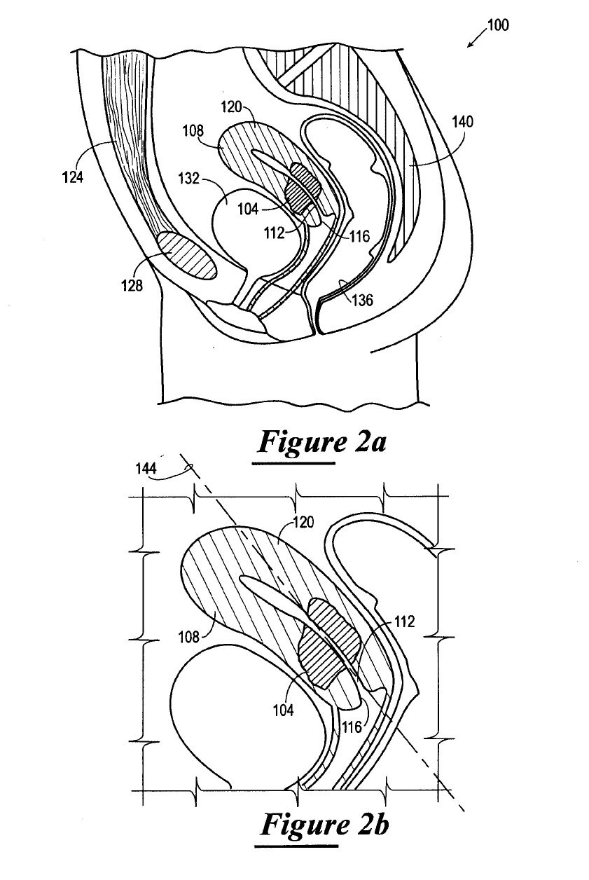

In one embodiment of use, the system functions, or is programmed to function as follows. In accordance with standard DCE-MRE techniques, the organism 34 is injected with a known amount of contrast agent at a known injection rate. The image recording device 14 captures at least one image 100, as depicted in FIG. 2. The image recording device 14 may capture a plurality of images 100 at known times, of tissue within the organism 34, for example, to pictorially capture several stages of relative absorption and release of the contrast agent by the tissue or to pictorially capture several stages of tumor growth over a period of time.

The computer apparatus 18 accesses the at least one image 100, and displays the at least one image 100 to a user, via the display 42. A region of interest 104, such as a tumor, is identified in the tissue of the image 100. As the region of interest 104 is depicted as a tumor 104, these two terms may be used interchangeably hereinafter. However, it should be understood that the region of interest 104 may be nearly any region on or within the organism 34 for which it is desirable to gain a greater understanding of, or deliver treatment. Additionally, although the following description is related to medical imaging, one skilled in the art will appreciate, the region of interest 104 may apply to all fields concerning and/or involving image segmentation, including, but not limited to: general photography, satellite imagery, face recognition systems, machine vision, and the like.

By way of example, the tumor 104 is located in the uterus 108 more proximal to the uterine stripe 112 and the cervix 116, and more distal from the corpus 120 of the uterus 108. For clarity, the uterus 108 is shown in FIG. 2 in context to the lower portion of a female human torso, and also depicted are the abdominal muscles 124, the pubic bone 128, the bladder 132, the large intestine 136, and the tail bone 140.

Referring now to FIG. 2b, an enlarged view of the region of interest 104 within the uterus 108 is shown. Generally, it is desirable to positionally reference the region of interest 104 to a biological landmark of the organism 34. To this end, an axis 144 is preferably chosen to align with such a biological landmark and preferably to intersect an approximate center of volume of the tumor 104. The axis 144 is preferably identified or selected by a user, such as a doctor, a resident, a surgeon, a lab technician, or the like, and input into the computer apparatus 18, via the input device 46 (FIG. 1). In other embodiments, the computer apparatus 18 (FIG. 1) may be programmed to automatically place the axis 144 to correspond with one or more of a plurality of predetermined biological reference points within a body, such as bones, portions of bones, organs, portions of organs, glands, blood vessels, nerves, or the like.

In the example shown, the axis 144 is aligned with the uterine stripe 112 so as to extend from the cervix 116 in the direction of the corpus 120 of the uterus 108. This orientation is especially advantageous for analysis of a tumor 104 in the uterus 108 due to the differences in circulation between the corpus 120 and the cervix 116, which can result in heterogeneity of vascularity and perfusion rates within different portions of the tumor 104. The axis 144 positionally references the tumor 144 to the uterus 108, and thereby the uterine stripe 112, the cervix 116 and the corpus 120.

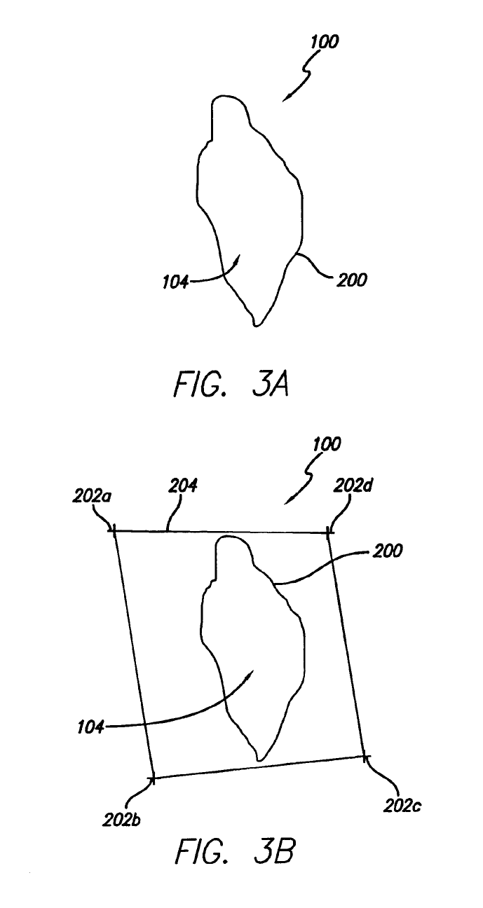

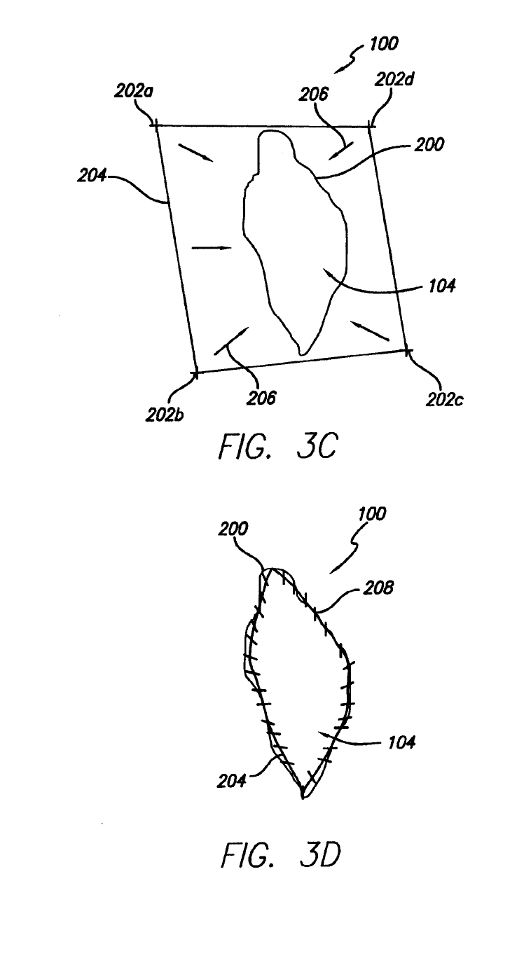

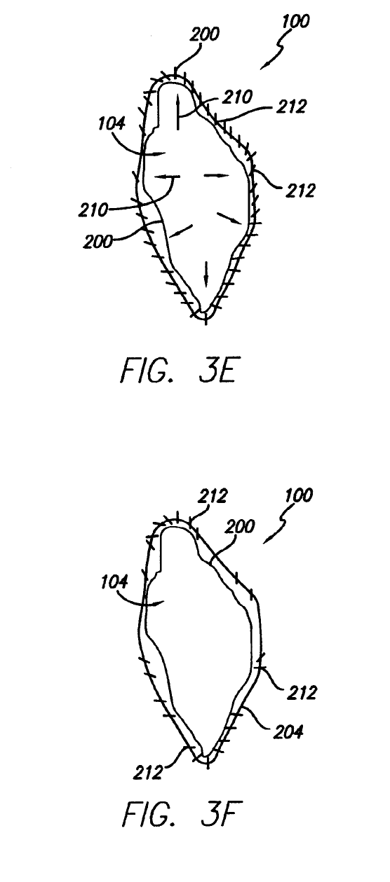

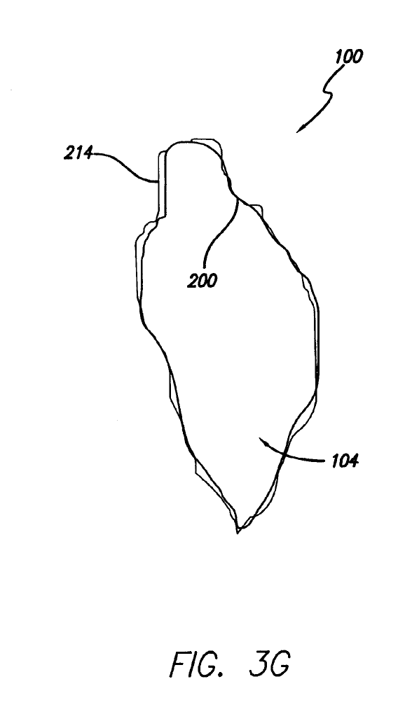

As best shown in FIGS. 3a-g, iterative deformational methodology is used to provide semi-automated and/or manually segmentation of the region of interest 104 of the image 100. Generally, each region of interest 104 includes one or several image boundaries 200. For example, the region of interest 104 may include an organ boundary, a tumor boundary, and/or the like. The region of interest 104 in FIG. 3a includes the tumor boundary 200.

At least two starting points 202 are selected on either the exterior of the image boundary 200 or the interior of the image boundary 200. The user may manually select the at least two starting points 202 through use of the input device 46. Alternatively, the starting points 202 may be automatically generated. For example, the starting points 202 may be automatically generated through statistical analysis based on bright-to-dark and/or dark-to-bright contrast of the image 100.

In the embodiment illustrated in FIG. 3b, four starting points 202a, 202b, 202c, and 202d are selected on the exterior of the image boundary 200. A contour line 204 is approximated and formed connecting the starting points 202a-d. It should be noted that any number of starting points 202 may be selected as long as the contour line 204 can be formed around the image boundary 200. Preferably, a minimal number of starting points 202 are selected in order to reduce the physical range of motion required by a user during manual entry of starting points 202 as described herein above.

Alternatively, the computer apparatus 18 may incorporate the use of template matching in defining the contour line 204 in addition to or in lieu of user-defined or automatically defined starting points 202. A template may be manually or automatically selected from a library of structures and/or templates. For example, the user may manually select a template that closely approximates the shape of the image boundary 200 or an organ of interest. Alternatively, the template may be automatically pre-selected based on correlation data associated with the image boundary 200.

Referring now to FIG. 3c, a first iteration process 206 initiates from the contour line 204 formed by the starting points 202a-d and/or template. The first iteration process 206 uses a deformable model to deform the contour line 204 to the image boundary 200.

In one embodiment, the deformable model may be similar to the classic snake known within the art. This version of the deformable model includes a polygonal model where the vertices fall on:

v(s)=[x(s)y(s)]^{T} (EQ 1)

In this model, s is parameterized on the interval between 0 and 1 and x and y are 2D coordinates. The equation that describes energy minimization is as follows:

$${E}_{Deform} = {\int }_{0}^{1} {E}_{Internal} ( v ( s ) ) d s + {\int }_{0}^{1} {E}_{External} ( v ( s ) ) d s \qquad ( EQ 2 )$$

where Eᵢₙₜₑᵣₙₐₗ represents the energy of a contour due to bending, Eₑₓₜₑᵣₙₐₗ gives rise to image-derived forces that attract a spline to the region of interest 104 from bright-to-dark or from dark-to-bright. This choice may be initialized by the user, which is dependent on the image 100 and/or the region of interest 104:

$${E}_{Internal} = {w}_{1} ( s ) {\vert \frac{d v}{d s} \vert}^{2} + {w}_{2} ( s ) {\vert \frac{{d}^{2} v}{d {s}^{2}} \vert}^{2} \qquad ( EQ 3 )$$

where w₁ and w₂ are weights that model elasticity and stiffness qualities, respectively.

$$\begin{matrix}{E}_{External} = {\int }_{0}^{1} P ( v ( s ) ) d s & ( EQ 4 ) \\ P ( x , y ) = - c \vert ∇ [ {G}_{σ} ⊗ I ( x , y ) ] \vert & ( EQ 5 )\end{matrix}$$

For the external energy expression, in two dimensions, P(v(s))=P(x.y) represents the flow to the object based on gradient of gaussian smoothed image I(x,y), where G_{σ} is a Gaussian function with a standard deviation of σ and c is a coefficient in which the user may provide initial estimates. The deformation spline converges to locations of strong edges in the image. After Euler Lagranage Formulation, this becomes:

$$- \frac{d}{d t} ( {w}_{1} \frac{d v}{d s} ) + \frac{{d}^{2}}{d {s}^{2}} ( {w}_{2} \frac{{d}^{2} v}{d {s}^{2}} ) + ∇ P ( v ( s ) ) = 0 \qquad ( EQ 6 )$$

Using the variational form above in which w₁ and w₂ shown in EQ (2) are selectable parameters. This can be used to form:

$${v}_{i}^{( t + Δ t )} = {v}_{i}^{( t )} - \frac{Δ t}{γ} ( a {α}_{i}^{( t )} + b {β}_{i}^{( t )} - {ρ}_{i}^{( t )} - {f}_{i}^{( t )} ) \qquad ( EQ 7 )$$

where α₁ model tensile forces and β₁ model flexural forces that originate from the internal energy terms reflecting the first and second terms of EQ (7), respectively. The fᵢ terms represent the external forces from the third term in EQ (7) and reflect contributions from external energy term as shown in EQ (4) with EQ (5) substitution. The final term of EQ (7), fᵢ, models an inflationary force that is intended to improve performance of the algorithm in the presence of local minima. It is also used to set the preferred direction bright-to-dark or dark-to-bright locally along the deformable model path.

In another embodiment, the direction for movement of the vertices along the deformable model path from ‘bright-to-dark’ or ‘dark-to-bright’ is set through the inflationary force term of EQ (7). In brief, for each vertex vᵢ(s) in the current deformable path two adjacent vertices vᵢ₋₁(s) and vᵢ₊₁(s) that are in the sequential circular order to the original vertex vᵢ(s) along the path are identified. The line \vec{L} is constructed between vᵢ₋₁(s) and vᵢ₊₁(s). The location contained on that line \vec{L} that is the closest in distance to the original vertex vᵢ(s) is identified and as point cᵢ(s). The entire image is then normalized by a linear scaling such that the original minimum value of the image will be set to 0 and the maximum value to 1 in the resultant normalized image Iₙₒᵣₘ. An interpolation is performed from the normalized image to evaluate signal intensity value at point cᵢ(s). The intensity of the point to be evaluated is Iₙₒᵣₘ(cᵢ(s)). The value T₀ is a threshold constant assigned by the user. If the process is moving from dark pixels to bright pixels and Iₙₒᵣₘ(cᵢ(s))>T₀ then the scalar term Fᵢ is set to 1, otherwise Fᵢ is set to −1. It should be noted that Fᵢ reflects a scalar component of the inflationary force term in (EQ 7). Alternatively, if the process has been set to prefer bright-to-dark pixels and the Iₙₒᵣₘ(cᵢ(s))<T₀ then Fᵢ is set to −1, otherwise Fᵢ is set to 1. The inflationary term fᵢ that is incorporated into (EQ 7) can be calculated from:

f₁=K*Fᵢ_{₁}*\hat{n} (EQ 8)

where \hat{n} is the unit vector (normal to the line) between cᵢ(s) and vᵢ(s) and K is a constant term set by the user.

It will appreciated by one skilled in the art, that other deformation models known in the art may be used for the first iteration 206 and/or other iterations described herein. Additionally, in general, it is contemplated that a level set may be used for the first iteration 206 and/or other iterations described herein.

As illustrated in FIG. 3d, as the contour line 204 approaches the image boundary 200 during the first iteration process 206, the user may manually interrupt or cease the iteration. For example, the user, through a verbal command, input of a keystroke, click of a mouse, or other similar mechanism ceases the iteration process. Cessation of the iteration provides a first series of at least two contour points 208. The user may manually adjust the contour points 208, as needed, to further deform the contour line 204 to the image boundary 200.

Referring to FIG. 3e, a second iteration 210 adjusts the contour line 204 in the opposing direction of the first iteration 20, such that the contour line 204 further deforms to the image boundary 200. The deformable model for the second iteration 210 may be similar to the classic snake known within the art as described herein. It will appreciated by one skilled in the art, that other deformation models known in the art may be used for the second iteration 210 and/or other iterations described herein.

Similar to the first iteration, as the contour line 204 approaches the image boundary 200 during the second iteration 210, the user may manually interrupt or cease the iteration. For example, the user, through a verbal command, input of a keystroke, click of a mouse, or other similar mechanism ceases the iteration process. Interrupting the iteration provides a second series of at least two contour points 212 on the contour line 204. The user may manually adjust the contour points 212, as needed, to further deform the contour line 204 to the image boundary 200.

The first iteration 206 and the second iteration 210 are opposing iteration that have the ability to be repeated an unlimited amount of times (e.g. third iteration, fourth iteration, etc). Updated contour points 208 and/or 212 for each iteration 206 and/210 may be selectively saved within the computer apparatus 18 (FIG. 1) for retrieval and/or analysis.

In one embodiment, the computer apparatus 18 (FIG. 1) may provide a thinning algorithm to reduce the number of contour points after each iteration. For example, FIG. 3f illustrates the use of a thinning process wherein the number of contour points 212 is reduced. Reducing the number of contour points 212 provides for the simplification of subsequent iterations. In one embodiment, the thinning algorithm is based on Euclidean distance and/or priority score. In another embodiment, the thinning algorithm is based on the relative separative distance between contour points 212. For example, if two contour points 212 are in a substantially similar position, one contour point is eliminated. In another embodiment, the thinning algorithm selectively eliminates every other contour point 212. For example, if iteration of the contour line 204 provides contour points 212₁₋ₓ, the thinning algorithm may eliminate all even numbered contour points, i.e. 212₂, 212₄, etc.

In another embodiment, the computer apparatus 18 (FIG. 1) may provide for digital image processing between iterations. For example, a morphological filter may be applied to the entire image 100, or the region of interest 104 within the image. Morphological filters may include operations such as erosion and/or dilation well known within the art. Application of the morphological filter on the region of interest 104 may reduce the number of contour points 208 and/or 212. The reduced number of contour points 208 and/or 212 are then iterated in the opposing direction as detailed above.

Through opposing iterations, (i.e. the first iteration 206, the second iteration 210, and any subsequent iterations as needed), the contour line 204 deforms to the image boundary 200 delineating the initial boundary line 214 as illustrated in FIG. 3g. Through the delineation of the initial boundary line 214, an object within the image boundary 200, such as a tumor, can be isolated from the surrounding image for quantification, analysis, and/or reconstruction of a geometric representation of the object. A treatment plan may be prepared using the initial boundary line 214 as a reference and/or guide.

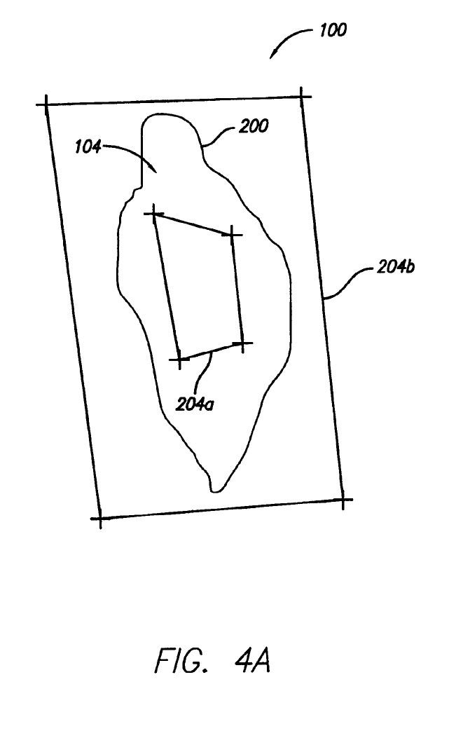

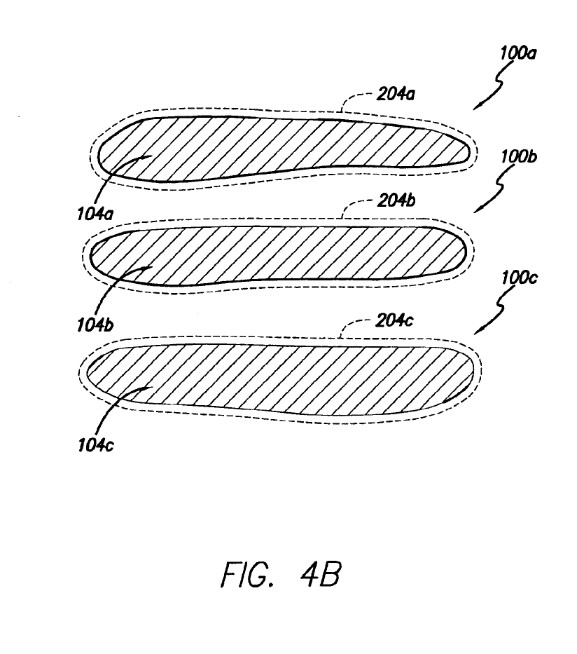

In another embodiment as illustrated in FIG. 4, the computer apparatus 18 (FIG. 1) may provide two or more contour lines 204a and 204b deforming to the image boundary 200. The contour lines 204a and 204b may be placed simultaneously internal, simultaneously external, or simultaneously internal and external to the image boundary 200. FIG. 4 illustrates contour line 204a external to the image boundary 200, and contour line 204b internal to the image boundary 200. Each contour line 204a and 204b may be iterated using methods described herein to provide series of contour points 208 and/or 212. For example, the contour line 204a provides a first series of contour points 208a. The contour line 204b provides a first series of contour points 208b. Overlap between the contour points 208a and the contour points 208b may be tracked using dynamic programming, edge detection, or any related method to provide delineation of the image boundary 200. The use of multiple contour lines 204a and 204b can assist in the creation of invaginating demarcations.

In another embodiment, the computer apparatus 18 is able to interpolate the initial boundary line 214 based on the delineation of two or more images 100 within a sequence. Interpolations of image boundary lines 200 increase the efficiency of the delineation process for a sequence of images. For example, as illustrated in FIG. 4b, the computer apparatus 18 analyzes and performs opposing iterations on a first image 100a to delineate the first image boundary line 200a. Additionally, the computer apparatus 18 analyzes and performs opposing iterations on a second image 100b to delineate the second image boundary line 200b. Using the delineations of the first image boundary lines 200a and the second image boundary line 200b, the computer apparatus interpolates the third image boundary line 200c.

In another embodiment, the computer apparatus 18 analyzes the initial boundary 214 provided by the multiple opposing iterations and compares the initial boundary 214 with a manually derived boundary line (not shown) provided by a user. The initial boundary 214 is a assigned a first value, and the manually derived boundary line is assigned a second value. Exemplary values may include sensitivity, repeatability, parameter value, functional values, and/or other similar entities. The computer apparatus 18 provides comparisons between the first value of the initial boundary 214 and the second value of the manually derived boundary line. For example, the first value of the initial boundary 214 may include volumetric representation. The computer apparatus 18 compares the volumetric representation of the initial boundary 214 with the volumetric representation of the manually derived boundary line. Comparison of the volumetric representations can provide the statistical precision of the initial boundary 214 to the manually derived boundary line. The statistical precision can identify a confidence level associative with the formation of the initial boundary 214 through the deformable model.

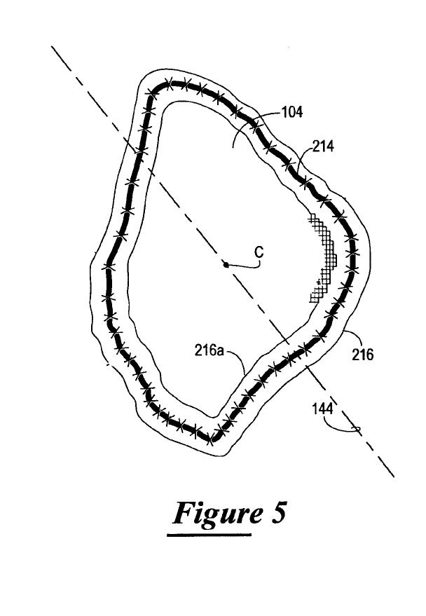

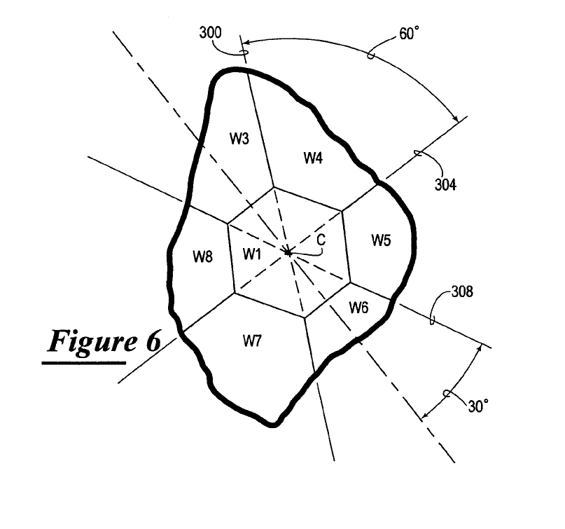

In another embodiment as illustrated in FIG. 5, the computer apparatus 18 (FIG. 1) analyzes at least one parameter for the region within the image boundary 200 to further adjust the initial boundary 214. The at least one parameter analyzed may be any useful parameter such as an anatomical, functional, or molecular parameter that may assist in evaluating the region of interest, such as by indicating metabolic activity or the like. For example, when the region of interest 104 is a tumor, the parameter may be a parameter indicative of tumor vascularity, perfusion rate, or the like. It is most preferable to select at least one parameter that is also useful in distinguishing the region of interest 104 from surrounding regions. For example, the tissue of a tumor will generally exhibit different perfusion characteristics than the surrounding healthy tissue. Thus, a parameter indicative of perfusion will generally assist in distinguishing the tumor 104 from surrounding tissues.

One example of a parameter recognized in the art as indicative of perfusion rate in a tumor 104 is commonly known as k_{1 2}. Tumor perfusion is often studied with what is known as a pharmacokinetic “two-tank” model, with the tissue surrounding the tumor represented by a first tank and the tissue of the tumor represented by the second tank. k_{1 2} is simply a parameter indicative of the rate at which the tissue of the tumor 104 absorbs the contrast agent from the surrounding tissue. As will be appreciated by those skilled in the art, such parameters may also be modeled with pharmacokinetic models having more than two tanks, for example, three, four, or the like. Because k_{1 2} is only one example of a suitable parameter, and because such modeling, and specifically the k_{1 2} parameter, is well known in the art, no further description of the at least one parameter is deemed necessary to enable implementation of the various embodiments of the present invention. Other parameters that may be used include k_{2 1}, amplitude, relative signal intensity (RSI), other pharmacokinetic parameters, VEGF, or the like.

After the at least one parameter is analyzed for the region within the initial boundary 214, the initial boundary 214 is adjusted so as to identify an adjusted boundary 216. The initial boundary 214 is preferably adjusted outward or inward by a predetermined amount, such as by offsetting the initial boundary 214 a pre-determined distance, or by offsetting the initial boundary 214 so as achieve a pre-determined change in volume or area of the region within the image boundary. In other embodiments, the initial boundary 214 may be adjusted manually to identify the adjusted boundary 216, or in any other manner which may directly or indirectly assist a user or the computer apparatus in analyzing or evaluating the accuracy of the initial boundary 214 or in ascertaining a more accurate boundary of the tumor 104.

After the adjusted boundary 216 is identified, the computer apparatus 18 preferably calculates a region difference indicative of the change in size between the initial boundary 214 and the adjusted boundary 216. The computer apparatus 18 (FIG. 1) then preferably analyzes the at least one parameter for the region within the adjusted boundary 216 such that the at least one parameter for the initial boundary 214 can be compared to the at least one parameter for the adjusted boundary 216 and the change therebetween can be compared to the region difference to assist in determining whether the adjusted boundary 216 is more or less accurate than the initial boundary 214, or to assist in otherwise evaluating the accuracy of a boundary of the tumor 104.

For example, when the k_{1 2} parameter is analyzed and compared for both boundaries 214 and 216, a large decrease in k_{1 2} for a given region difference, i.e. change in size from the initial boundary 214 to the adjusted boundary 216, may indicate that a significant amount of non-cancerous tissue is included in the adjusted boundary 216. Such a result would indicate to either a user or to the computer apparatus 18 (FIG. 1) that the adjusted boundary 216 should be adjusted inward toward the initial boundary 214 and the k_{1 2} parameter re-analyzed and re-compared to the k_{1 2} parameter for the initial boundary 214.

Similarly, the initial boundary 214 can be adjusted inward to identify an adjusted boundary 216a, and the process of analyzing the at least one parameter for the adjusted boundary 216a and comparing the at least one parameter for the adjusted boundary 216 and the at least one parameter for the initial boundary 214 performed, as described above, for the adjusted boundary 216a. For example, when the k_{1 2} parameter is analyzed and compared for both boundaries 214 and 216a, a large increase in k_{1 2} for a given region difference, i.e. change in size from the initial boundary 214 to the adjusted boundary 216a, may indicate that a significant amount of non-cancerous tissue is included in the initial boundary 214. Such a result would indicate to either a user or to the computer apparatus 18 (FIG. 1) that the initial boundary 214 should be adjusted inward toward the adjusted boundary 216a and the k_{1 2} parameter re-analyzed and re-compared to the k_{1 2} parameter for the adjusted boundary 216a.

The parameter for the initial boundary and adjusted boundaries 214, 216, and 216a can then be compared to a reference to assist in evaluating the accuracy of the delineation of the tumor. For example, the reference could be an acceptable limit on the change in k_{1 2}, i.e. 5%, such that when a given region difference results in a parameter difference greater than 5%, the process can be repeated with an adjusted boundary 216 or 216a that is closer to the initial boundary 214. The reference could also be generated by an evaluation of the at least one parameter for a number of adjusted boundaries 216 and/or 216a such that a curve can be fit to the data and the reference could be a sharp change in slope of the data or any other deviation that may be indicative of the accuracy of any of the boundaries 214, 216, and/or 216a. In yet further embodiments, the reference could be a predetermined limit on the permissible parameter difference per unit volume change.

The parameter difference may be compared to the reference either manually or in automated fashion, and may be compared either in absolute, relative, normalized, quantitative, qualitative, or other similar fashion. A positive comparison is indicative that the subsequent adjusted boundary 216 or 216a is more accurate than the initial boundary 214 or a previous adjusted boundary 216 or 216a, to which it is compared. Similarly, a negative comparison is indicative that the subsequent adjusted boundary 216 or 216a is less accurate than the initial boundary 214 or a previous adjusted boundary 216 or 216a, to which it is compared. Additional embodiments may also be provided with a neutral comparison which is indicative that the subsequent adjusted boundary 216 or 216a is more accurate than the initial boundary 214 or a previous adjusted boundary 216 or 216a, to which it is compared, but is less accurate than desired, such that the process of adjustment and comparison should be repeated to achieve a more accurate result. In response to a neutral comparison, the initial boundary 214 may be replaced with the adjusted boundary 216 or 216a, such that a subsequent initial boundary 216 or 216a will be compared to the replaced initial boundary 214.

In one preferred embodiment, the initial boundary 214 is iteratively adjusted for a number of incremental increases and decreases in the volume of the tumor 104 to identify a number of adjusted boundaries 216 and 216a, respectively. For example, the initial boundary 214 may be iteratively adjusted to increase the volume within the initial boundary by 5%, 10%, 15%, and so on to identify an equivalent number of corresponding adjusted boundaries 216; and the initial boundary 214 may be iteratively adjusted to decrease the volume within the initial boundary 214 by 5%, 10%, 15%, and so on, to identify an equivalent number of corresponding adjusted boundaries 216a.

The iterative adjustments are repeated for a pre-determined number of iterations, for example, to identify the change in the at least one parameter for adjusted boundaries 216 and 216a between the range of volume increases and decreases between 100% and −90%, respectively. The at least one parameter, such as k_{1 2}, is then analyzed for each of the adjusted boundaries 216 and 216a and compared to the at least one parameter for the initial boundary 214. The at least one parameter for each of the adjusted boundaries 216 and 216a is then be plotted or compared, in absolute or normalized fashion, against the respective region change for each of the adjusted boundaries 216 and 216a, as well as the initial boundary 214; and the data modeled manually or by a curve-fitting algorithm to obtain a curve indicative of the change in the at least one parameter relative to the region change for each of the boundaries 214, 216, and 216a. As will be appreciated by those skilled in the art, the resulting curve can then be analyzed by a user or by the computer apparatus 18 so as to identify any sharp changes in slope or other deviations indicative of accurate limits of the region of interest 104.

In another embodiment, the one or more adjusted boundaries 216a are compared to the one or more adjusted boundaries 216, so as to make the process more sensitive to changes in tissue characteristics near the limits of the tumor 104. For example, since the center of the tumor 104 an be ascertained with relative certainty, and because calculating the at least one parameter for the entire region within the initial boundary 214 includes tissue of relatively known properties; excluding the region within the inner adjusted boundary 216a and only calculating the at least one parameter between the adjusted boundary 216a and the adjusted boundary 216, makes the process more sensitive to changes in tissue characteristics between iterative adjusted boundaries 216. Specifically, excluding the volume of tissue within the adjusted boundary 216a reduces the amount of tissue of known characteristics over which the at least one parameter is analyzed and averaged. Thus, when non-cancerous, or otherwise differentiable tissues are included in an outer adjusted boundary 216, the resulting difference in the at least one parameter will be averaged over a much smaller volume of tissue, and the change will be more pronounced and noticeable.

Once the image boundary 200 is identified, that is, the user is satisfied that the initial boundary 214 closely or approximately delineates the region of interest 104, it will be appreciated by those skilled in the art that the foregoing method of identifying the image boundary 200 may be repeated for each of a plurality of two-dimensional images 100 such that the computer apparatus 18 may interpolate between the plurality of two-dimensional images 100 so as to form a three-dimensional model or image of the region of interest 104.

Similarly, in the case of a three-dimensional image 100, it may be desirable to select the image boundary 200 for each of a plurality of slices of the three-dimensional images 100, such that the computer apparatus 18 can interpolate between the plurality of slices to form a three-dimensional image boundary 200 for the entire three-dimensional image 100. In some embodiments, the computer apparatus 18 may be programmed to “learn” from the manual identification of the image boundary 200 in one or more individual slices of a three-dimensional image, model, or other representation, or in one or more two-dimensional images; such as by recognizing the difference in relative contrast, color, shade, or the like between adjacent pixels on opposite sides of the manually-identified initial boundary, so as to essentially mimic the manual identification of the user. In such a way, the computer apparatus 18 can more accurately re-create the manual identification of the image boundary 200 on one or more slices so as to more accurately identify a three-dimensional initial boundary around and/or between the one or more slices.

During the delineation process, visual metrics may be provided by the computer apparatus 18 (FIG. 1) to gauge progress and/or accuracy. For example, metrics quantifying and/or periodically assessing use of the delineation process may provide feedback to the user on the accuracy and/or effectiveness of the user's selections. Such selections may include the user's manually selected starting points 202 and/or contour points 208 and 212. Visual metrics may be useful during initial training of users. As is well known in the art, expertise in image segmentation is attained after several years of experience and exposure. Visual metrics may accelerate the learning process by providing a feedback mechanism to the user.

Additionally, the computer apparatus 18 (FIG. 1) may incorporate the use of artificial intelligence and/or neural nets to enhance the delineation process. For example, an algorithm providing for the accumulation of repetitive information may allow the computer apparatus 18 (FIG. 1) to automatically or semi-automatically adjust parameters based on repetitive manual entries of the user. Such parameters may include, for example, the tensile forces and/or flexural forces.

The computer apparatus 18 (FIG. 1) may also provide for a sequence of images 100 of the iterations that can be projected with sufficient rapidity to create the illusion of motion and continuity. Generally, the computer apparatus 18 (FIG. 1) may selectively store the sequence of images during the first iteration process 206. Once stored, the computer apparatus 18 provides the sequence to the user. The user has the ability to forward through and/or reverse the sequence of images to determine any errors or demonstrate optimal segmentation. During playback, the computer apparatus 18 (FIG. 1) may also provide a mechanism for manually altering and/or adjusting deformation of the contour line 204 along the image boundary 200. The manually altered contour line 204 may be further used throughout subsequent iterations.

Providing playback of a sequence of images 100 allows for each iteration to become a video for teaching and/or modifying. For example, an expert may review the sequence of images and manually tune the deformation of the contour line 204. The manually altered contour line 204 is then further used throughout subsequent iterations. A resident may also use the playback as a teaching tool. The resident may study the past iterations provided by an expert user in order to gain knowledge within the field.

Delineation of the image boundary 200 may be used as a tool for planning a method of radiation therapy by improving the accuracy with which a tumor is identified. Through opposing iterations of the image boundary 200, the tumor 104 may be identified and tissue external to the tumor 104 excluded. As such, radiation can then be targeted solely to the tumor 104.

Delineation of the image boundary 200 may also be used as a tool to diagnosis existing or developing conditions. The images 100 analyzed by the computer apparatus 18 may be accessed over several days, months, years, and/or the like to provide information on the existing or developing condition. For example, images 100 of a tumor 104 may be provided on a monthly basis. The delineation of the image boundary 200 of the tumor 104 may provide information on the relative growth of the tumor 104, the development of the tumor 104, and other similar information of interest to a physician.

In practice any one or more, or combination of, the above methods, including simple manual delineation, may be used to identify an accurate boundary, e.g. 214, 216, or 216a, of the tumor 104. In one embodiment, once the tumor 104, or other region of interest 104, is identified, the computer apparatus 18 implements known numerical methods or other algorithms to determine a centroid C, which is preferably the center of volume or center of mass, of the tumor 104. The centroid C may also be manually selected, for example, by a user, in any methodical or arbitrary fashion. Similarly, multiple centroids C may be selected for a single tumor 104, such as for multiple sections or partitions of a tumor; as well as for multiple tumors 104 within an image. Preferably, the axis 144 is then, either manually or by the computer apparatus 18, adjusted to intersect the centroid C, while maintaining some alignment, or other relation or reference to, one or more biological landmarks, in this example, the uterine stripe 112, and/or other portions of the uterus 108 (FIGS. 2a and 2b).

Referring now to FIG. 6, an enlarged side view of the tumor 104 is depicted. As shown, the tumor 104 is preferably divided into a plurality of segments, W1, W2 (not shown), W3, W4, W5, W6, W7, and W8; with each of the segments W1-W8 positionally referenced to a biological landmark of the organism 34 (FIG. 1), such as, in this example, the uterine stripe 112, or other portion of the uterus 108, as discussed above. The segments W1-W8 may be qualitatively or quantitatively positionally referenced to the biological landmark, and/or may be directly or indirectly positionally referenced to the biological landmark. For example, because the axis 144 is positionally referenced to the biological landmark, the wedges W1-W8 may be positionally referenced to the biological landmark indirectly, by way of the axis 144 and/or the centroid C.

In one preferred embodiment, the tumor 104 is divided into six equiangular wedges W3, W4, W5, W6, W7, and W8, by cut planes 300, 304, and 308; and is further divided to include two conical segments W1 and W2 projecting outward on each side of the tumor 104 from the centroid C. Thus, only segment W1 is shown in the side view of FIG. 6, but segment W2 projects outward toward the opposite side in a manner equivalent to that of segment W1. In another embodiment (not shown), a tumor, or other region of interest may be divided into one or more radially-defined layers, for example, similar to the layers of onion.

The positions of the cut planes 300, 304, and 308 are preferably selected in relation to the biological landmark. Specifically, the tumor 104 shown in the figures is referenced to the uterus 108. One known characteristic of the uterus 108 is that, generally, there is greater circulation toward the corpus 120 than toward the cervix 116. Therefore, the cut planes W3-W8 are oriented to as to optimally reflect any resulting heterogeneity within the tumor 104. Specifically, three wedges W3, W4, and W8 lie on the side of cut plane 304 facing the corpus 120 of the uterus 108, and three wedges W5, W6, and W7 lie on the side of the cut plane 304 facing the uterus. As shown, this orientation is achieved by orienting cut plane 300 at a thirty degree angle from the axis 144, and orienting cut planes 304 and 308 at sixty degree angular increments from one another and from cut plane 300. All three cut planes 300, 304, and 308 are perpendicular to a plane (not shown) that bisects the human torso shown in FIG. 2a.

The conical segments W1 and W2 (not shown) are created by protecting a hexagonal cone outward from the centroid C. The sides of the conical segments W1 and W2 are preferably disposed at an equal angle from an axis parallel to all three cut planes 300, 304, and 308, and intersecting the centroid C. This angle may be predefined, selected by a user, automatically calculated to obtain conical segments W1 and W2 of approximately equivalent volume to the wedge segments W3-W8, or in any other suitable manner. In the case of the tumor 104 lying in the uterus 108, as shown, the conical segments W1 and W2 have been found to demonstrate very little variance in perfusion, and therefore, may be omitted entirely without significant detriment.

In other embodiments, or as advantageous for particular applications of the present invention, a tumor or other region of interest 104 may be divided into any number of wedges, for example 4, 5, 8, or the like, and may be spaced in an equiangular fashion, as shown, or may be disposed at, or defined by, varying or unequal angular locations. Similarly, the tumor or other region of interest 104 may be divided into segments of any shape, size, number, or the like, so long as they are positionally referenced to a biological landmark, such as, in this example, the uterine stripe 112, or other portion of the uterus 108, as discussed above.

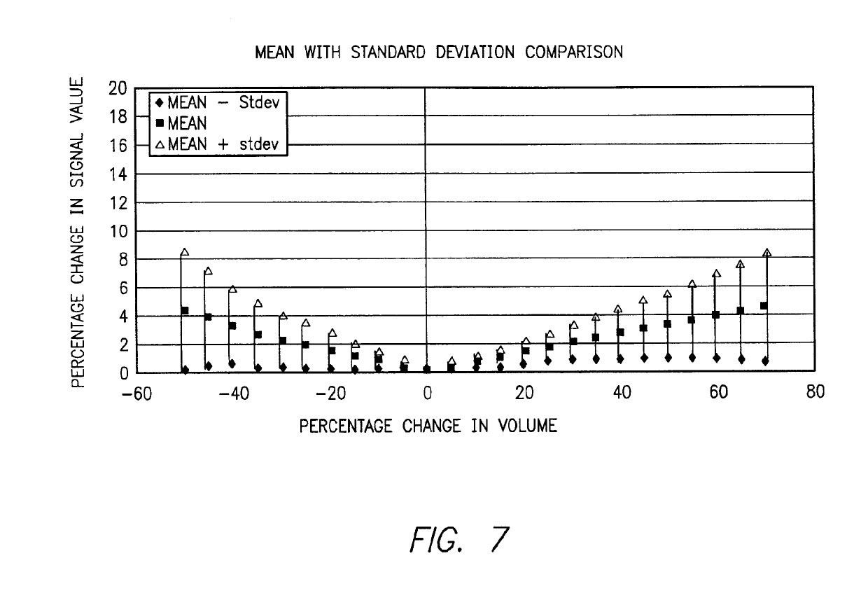

Once the tumor 104 is divided into the plurality of segments W1-W8, either manually by a user via input device 46 (FIG. 1), or by the computer apparatus 18 (FIG. 1), the computer apparatus 18 preferably registers the plurality of segments W1-W2 of the tissue in the image 100 (FIG. 1). The computer apparatus 18, then analyzes at least one parameter for at least one, and preferably all, of the plurality of segments W1-W8. In the case of a tumor 104, the computer apparatus preferably analyzes at least one factor indicative of tumor vascularity, perfusion, or the like, such as are well-known in the use of DCE-MRI technology. For example, as described above, the relative contrast between voxels in the preferred three-dimensional image 100 can be analyzed to indicate relative perfusion rates, and thus vascularity, within each of the segments W1-W8. FIG. 7 depicts an exemplary mean signal response distribution for the tumor 104, obtained using known DCE-MRI techniques. The segments W3, W4, and W8 with relatively higher values have absorbed more contrast agent, and can therefore be determined to be relatively more vascular and have resulting higher rates of perfusion, than the segments with relatively lower values W5, W6, W7.

In the preferred embodiment, the at least one parameter is calculated individually for each of the voxels and the at least one parameter is then aggregated for all of the voxels within an individual segment, for example, segment W3. The at least one parameter can be aggregated for a given segment by any suitable numerical method or algorithm. For example, a parameter may be averaged over all of the voxels in segment W3, may have disparate values removed and the remaining voxels averaged, may be curve-fit to reduce the error by attempting to eliminate disparate values, or may be aggregated over the segment W3 by any other suitable method. In the interest of time and efficiency, the analysis of the at least one parameter for the segments W1-W3 is preferably completed by a program or algorithm of the computer apparatus 18. In other embodiments, the at least one parameter may be aggregated before being analyzed or may be analyzed and aggregated in a single step. For example, the computer apparatus 18 may be programmed to blur, or graphically average, the colors or gray shades of the voxels in a segment into a single color or gray shade, which may then be analyzed by the computer apparatus 18 over the entire segment.

In other embodiments, the at least one parameter may be a qualitative parameter, such that the analysis may be completed by a user. For example, the computer apparatus 18 can be programmed to blur, or graphically average, the colors or gray shades of the voxels of a segment into a single color or gray shade. The resulting color or gray shade could then be output to a user on a screen or printed sheet, such that the user could manually analyze the at least one parameter by comparing the color or gray shade to a reference chart or the like of known colors or gray shades.

Once the at least one parameter has been analyzed, preferably for each of the segments W1-W8, the computer apparatus 18 implements suitable algorithms to determine a treatment pattern for the tumor 104. More specifically, the computer apparatus 18 preferably determines an optimal or desirable distribution for treatment of each of the segments W1-W8. In some embodiments or applications, it may be desirable to treat only a portion of a segment, or to treat only a portion of the segments W1-W8, and thus, to develop a treatment pattern indicative of such.

As an illustration, there is generally a limit on the amount of radiation therapy (RT) it is safe to treat an individual with. For example, if it is determined that an individual can only safely absorb 50 units of RT, the computer apparatus 18 is programmed to determine a treatment pattern to maximize the likelihood of success, i.e. killing the tumor tissue. For the mean signal response distribution of FIG. 7, the computer apparatus is programmed to distribute the 50 units of RT among the segments W1-W8 in accordance with their relative vascularity. Because it is known that RT is most effective in tissue with higher vascularity and rates of perfusion, the segments W3, W4, and W8 are preferably treated with relatively more RT.

The computer apparatus 18 can thus distribute the 50 units of RT in relative proportion to the mean signal response values relative to the sum of the mean signal response values for all of the segments W1-W8. Assuming segment W1 and segment W2 have identical values, this weighted distribution results in segment W1 being targeted with approximately 6.5 units of RT, W2 with 6.5 units, W3 with 6.3 units, W4 with 7.0 units, W5 with 6.0 units, W6 with 5.7 units, W7 with 5.7 units, and W8 with 6.3 units. In other embodiments, the computer 18 may be programmed to omit segments, such as segments W6 and W7, that are below a certain threshold, for example 1.9, from RT treatment so as to distribute the entire the entire 50 units of RT among segments W1-W5 and W8 that the RT will be more effective in treating. Preferably, the computer apparatus 18 would then provide a treatment pattern including at least one other type of treatment for segments W6 and W7, such as targeted chemotherapy or the like.

The treatment pattern may also be determined in any other suitable manner as well. In one embodiment, the treatment pattern is determined in relation to the position of the segment relative to the biological landmark. For example, if a segment is located near a particularly sensitive organ or nerve, the segment may be treated at a relatively lower level, or omitted entirely from a particular type of treatment. In another embodiment, the treatment pattern is determined in relation to both the at least one parameter and the position of the segment relative to the biological landmark. The treatment pattern may also be determined with any suitable algorithm, curve, or model. For example, the predicted response of a particular segment can be used to determine the appropriate type or types of treatment, relative amount of treatment, duration of treatment, or the like, for the particular segment.

Although the treatment pattern is described above as being determined by the computer apparatus 18 (FIG. 1), the treatment pattern may also be determined by the treatment apparatus 22. For example, the computer apparatus 18 can output data indicative of the analysis of the at least one parameter to the treatment apparatus 22, such that the treatment apparatus 22 determines the treatment pattern. Similarly, the computer apparatus 18 may output data indicative of the analysis of the at least one parameter to a user, such that the user determines the treatment apparatus manually, or with a remote computer (not shown).

Once a treatment pattern is determined, the treatment apparatus 22 (FIG. 1) delivers at least one type of therapy in accordance with the treatment pattern. Although the treatment apparatus 22 is described above as preferably an RT device, other embodiments of the treatment apparatus 22 may deliver any suitable type of therapy or combination of therapies. For example, the treatment apparatus 22 may be adapted to deliver radiation therapy (RT) and chemotherapy.

Although the methods above are generally described as being implemented by the computer apparatus 18, programmed to perform the various functions, it should also be understood that the methods may be implemented independently of the computer apparatus 18, and even independent of the system 10. Other embodiments of the system 10 may comprise a plurality of computer apparatuses 18, such that the various programming, functions, storage, may be distributed among two or more computer apparatuses 18.

What is claimed is:

1. An image analysis system comprising:
a computer apparatus programmed to access at least one image and to register a plurality of starting points, the starting points positionally referenced to an image boundary of a region of interest of the image, the computer apparatus further programmed to analyze and connect the starting points to form at least one contour line and to perform multiple opposing iterations on the contour line using a deformable model to delineate the image boundary.

2. The image analysis system of claim 1, wherein the at least one image comprises a plurality of images.

3. The image analysis system of claim 2, wherein the plurality of images are taken at known time points.

4. The image analysis system of claim 1, wherein the at least one image is a three-dimensional image.

5. The image analysis system of claim 1, further comprising an image recording apparatus for capturing the at least one image.

6. The image analysis system of claim 5, wherein the image recording apparatus is selected from the group consisting of: a magnetic resonance imaging device; an x-ray device, a nuclear imaging device, a computed tomographic imaging device, an ultrasonic imaging device, an MRI spectroscopy device, a positron emission tomographic imaging device, and a hybrid device.

7. The image analysis system of claim 1, further comprising:
a treatment apparatus for delivering at least one type of therapy planned with respect to at least a portion of the delineated image boundary.

8. The image analysis system of claim 7, wherein the type of therapy is selected from the group consisting of: radiation therapy, chemotherapy, drug therapy, surgical therapy, nuclear therapy, brachytherapy, heat therapy, laser therapy, and ultrasonic therapy.

9. The image analysis system of claim 1, wherein the computer apparatus is programmed to analyze and connect the starting points to form two contour lines and to perform multiple opposing iterations on each of the contour lines to delineate the image boundary.

10. The image analysis system of claim 1, wherein the computer apparatus is further programmed to register a plurality of segments of the region of interest, the plurality of segments divided relative to a biological landmark and each of the plurality of segments positionally referenced to the biological landmark.

11. The image analysis system of claim 10, wherein the computer apparatus is further programmed to analyze at least one parameter for at least one of the plurality of segments.

12. The image analysis system of claim 11, wherein at least one of the plurality of segments is wedge-shaped.

13. The image analysis system of claim 11, wherein at least a portion of the plurality of segments are arranged about at least one centroid of the region of interest.

14. The image analysis system of claim 13, wherein at least one of the plurality of segments is radially-defined about the at least one centroid.

15. The image analysis system of claim 11, wherein the image includes a plurality of pixels.

16. The image analysis system of claim 15, wherein the computer apparatus analyzes the at least one parameter for the at least one segment by analyzing the at least one parameter for each of the pixels in the at least one segment and aggregating the at least one parameter for at least a portion of the pixels in the at least one segment.

17. The image analysis system of claim 16, wherein the computer apparatus analyzes the at least one parameter for the at least one segment by aggregating at least a portion of the pixels in the at least one segment and analyzing the at least one parameter for the aggregated pixels.

18. The image analysis system of claim 1, wherein the computer apparatus is further programmed to analyze at least one parameter for the region within the image boundary to further adjust the contour line.

19. The image analysis system of claim 15, wherein the at least one parameter is selected from the group consisting of: k_{1 2}, k_{2 1}, amplitude, relative signal intensity, and pharmacokinetic parameters.

20. A method of analyzing at least one image, the method comprising the steps of:
accessing at least one image;
identifying a region of interest within the image;
defining at least two starting points relative to the region of interest within the image;
positionally referencing the at least two starting points to an image boundary;
connecting the at least two starting points to form a contour line;
performing opposing iterations of the contour line to delineate the image boundary of the region of interest.

21. The method of claim 20, wherein the step of accessing at least one image includes accessing multiple images at known time points.

22. The method of claim 21, further comprising the step of identifying at least one characteristic of the region of interest based on the delineation of the image boundary.

23. The method of claim 21, wherein the characteristic is the relative growth of a tumor.

24. The method of claim 20, further comprising the steps of:
dividing the region of interest into a plurality of segments relative to biological landmark of a living organism;
positionally referencing each of the plurality of segments to the biological landmark; and,
analyzing at least one parameter for at least one of the plurality of segments.

25. A method of treating a living organism, comprising the steps of:
accessing at least one image of tissue within a living organism;
identifying a region of interest of the tissue;
positionally referencing a series of starting points to an image boundary of a region of interest of the image;
connecting the starting points to form at least one contour line;
performing multiple opposing iterations on the contour line using a deformable model to delineate the image boundary; and,
delivering at least one type of therapy to at least of portion of tissue within the image boundary.

26. The method of claim 25, further comprising the step of analyzing at least one parameter for the region within the image boundary to further adjust the contour line.

27. The method of claim 25, further comprising the steps of:
dividing the region of interest into a plurality of segments;
positionally referencing each of the plurality of segments to a biological landmark of the living organism;
delivering at least one type of therapy to at least a portion of at least one of the plurality of segments in relation to the position of the at least one segment relative to the biological landmark.

28. The method of claim 27, wherein the region of interest is divided into a plurality of segments relative to the biological landmark.

29. The method of claim 27, further comprising the step of analyzing at least one parameter for at least one of the plurality of segments.

30. The method of claim 29, wherein the at least one type of therapy is delivered to the at least one segment in relation to the at least one parameter.

31. The method of claim 25, wherein the type of therapy is selected from the group consisting of: radiation therapy, chemotherapy, drug therapy, surgical therapy, nuclear therapy, brachytherapy, heat therapy, laser therapy, and ultrasonic therapy.

32. A method of operating an image analysis system including a computer apparatus, the method comprising:
operating the computer apparatus to access at least one image and to register a plurality of starting points, the starting points positionally referenced to an image boundary of a region of interest of the image; and
operating the computer apparatus to analyze and connect the starting points to form at least one contour line and to perform multiple opposing iterations on the contour line to delineate the image boundary.

33. The method of claim 32, wherein the image analysis system further includes an image recording apparatus, the method further comprising the step of operating the image recording apparatus to capture the at least one image prior to operating the computer apparatus to access the at least one image.

34. The method of claim 32, wherein the image analysis system further include a treatment apparatus, the method further comprising the step of operating the treatment apparatus to deliver at least one type of therapy within the delineated image boundary.

35. The method of claim 32, further comprising the steps of:
operating the computer system to register a plurality of segments of the region of interest of the image, the plurality of segments divided relative to a biological landmark of a living organism and each of the plurality of segments positionally referenced to the biological landmark; and,
operating the computer apparatus to analyze at least one parameter for at least one of the plurality of segments.

36. The method of claim 35, further comprising the step of operating the treatment apparatus to provides at least one type of therapy to the at least one segment in relation to the at least one parameter.

37. A method of identifying a region of interest in an image, comprising the steps of:
accessing at least one image of tissue within a living organism;
identifying an image boundary of a region of interest of the tissue;
performing a first analysis of the image boundary, comprising the steps of:
positionally referencing a series of starting points to the image boundary;
connecting the starting points to form at least one contour line;
performing multiple opposing iterations on the contour line using a deformable model to delineate the image boundary; and,
analyzing at least one parameter for the tissue within the delineated image boundary;
performing a second analysis of the delineated image boundary, comprising the steps of:
adjusting the delineated image boundary to identify an adjusted boundary;
calculating a region difference indicative of the change between the delineated image boundary and the adjusted boundary;
analyzing the at least one parameter for the tissue within the adjusted boundary;
analyzing a parameter difference indicative of the change between the at least one parameter for the delineated image boundary and the at least one parameter for the adjusted boundary;
comparing the parameter difference to a reference;
repeating the steps of performing a first analysis and a second analysis, responsive to a negative comparison;
replacing the delineated image boundary with the adjusted boundary, responsive to a positive comparison.

38. An image analysis system comprising:
a computer apparatus programmed to access at least one image and to register a contour line, the contour line positionally referenced to an image boundary of a region of interest of the image, the computer apparatus further programmed to perform multiple opposing iterations on the contour line to delineate the image boundary.

39. The image analysis system of claim 38, wherein the contour line is selected from a library of template contour lines based on a shape similar to the shape of the image boundary.

40. A method of analyzing at least one image, the method comprising the steps of:
accessing at least one image;
identifying a region of interest within the image;
defining at least two starting points relative to the region of interest within the image;
positionally referencing the at least two starting points to an image boundary;
connecting the at least two starting points to form a contour line;
performing a first iteration of the contour line to provide a first delineation the image boundary of the region of interest using a deformable model, the first delineation having a series of contour points;
providing a thinning algorithm to the series of contour points to obtain an updated contour line;
performing a second opposing iteration of the updated contour line using a deformable model to provide a second delineation of the image boundary of the region of interest;
repeating opposing iterations of the updated contour lines to provide a final delineation of the image boundary of the region of interest.

41. The method of claim 40, further comprising the step of providing a morphological filter to the contour line.

42. The method of claim 40, further comprising the step of providing a morphological filter to the updated contour line.

43. The method of claim 40, wherein at least one image is a three-dimensional image.

44. The method of claim 43, wherein the at least one image is the three-dimensional image including a time component.

45. A method of analyzing at least two images to delineate an image boundary of a region of interest using a deformable model, the method comprising the steps of:
accessing a first image;
identifying a region of interest within the first image;
defining at least two starting points relative to the region of interest within the first image;
positionally referencing the at least two starting points to a first image boundary within the first image;
connecting the at least two starting points to form a first contour line;
performing multiple opposing iterations on the first contour line using a deformable model to delineate the first image boundary;
accessing a second image;
identifying a region of interest within the second image;
defining at least two starting points relative to the region of interest within the second image;
positionally referencing the at least two starting points to a second image boundary within the second image;
connecting the at least two starting points to form a second contour line;
performing multiple opposing iterations on the second contour line using a deformable model to delineate the second image boundary;
accessing a third image;
interpolating a third contour line to delineate a third image boundary using the first contour line of the first image and the second contour line of the second image.
